(19) United States
(12) Patent Application Publication
(10) Pub. No.: US 2023/0112069 A1
(43) Pub. Date: Apr. 13, 2023

(54) SYSTEM AND METHOD FOR OBSERVATION-BASED ASSESSMENT AND RECRUITMENT OF DIVERSE EMPLOYEES

(71) Applicant: Christiana Care Health System, Inc., Wilmington, DE (US)

(72) Inventors: Randall Gaboriault, Media, PA (US); Kelsey Kosinski, Wilmington, DE (US)

(21) Appl. No.: 17/964,655

(22) Filed: Oct. 12, 2022

Related U.S. Application Data
(60) Provisional application No. 63/254,883, filed on Oct. 12, 2021.

(51) Int. Cl. G06Q 10/10; G06Q 10/06; G06V 20/52; G06V 40/20

(52) U.S. Cl. CPC G06Q 10/1053; G06Q 10/063112; G06V 20/52; G06V 40/20

(57) ABSTRACT

A computerized system for sensor-based assessment of abilities of a person, such as a job applicant, and of skills required in performing a role, such as a job. Sensor-gathered data is processed automatedly to assess ability of the person, and to identify skills. Data may be gathered actively during performance of an assessment task, or passively, separately from any assessment task. Similarly, sensor-gathered data is processed automatedly to identify skill requirements for performance of the role. The system then performs automated matching to identify a role/job that is compatible with the skills of the person/job applicant. Accordingly, job applicants may be assessed using an objective hardware/sensor-based assessment of observed/measured/tracked abilities/performance, e.g., to determine physical, cognitive and/or social abilities. Thereby, the system may be used to remove personal bias and subjectivity (e.g., in hiring processes) by systematically capturing and matching an individual's skills to the skill requirements of a role.

### CROSS-REFERENCE TO RELATED APPLICATION

This application claims the benefit of priority of U.S. Provisional Patent Application No. 63/254,883, filed Oct. 12, 2021, the entire disclosure of which is hereby incorporated herein by reference.

### FIELD OF THE INVENTION

The present invention relates generally to computerized systems having artificial intelligence capabilities, and more specifically, to a computerized system and method for objective sensor-based observation and artificial-intelligence-driven analysis of physical, cognitive and social characteristics and abilities of a person, and the automated matching of the person to available job opportunities for recruiting purposes based on the various requirements of various jobs.

### DISCUSSION OF RELATED ART

This present invention not only helps create more job opportunities for individuals that may have had difficulty finding appropriate jobs previously, but also increases job placement satisfaction.

People living with a disability, minority races, women, etc. can benefit from this solution because it removes any bias that may exist during the hiring process. Hiring companies can benefit because this solution objectively ensures that the candidate has the necessary characteristics for the position, reducing employee turnover. Potential candidates can benefit because the solution will ensure they are the right person for the job.

Currently, job placement is a very much a manual process. Job applicants may not be fully aware of personal strengths and weaknesses, and recruiters may not be able to readily adequately assess such personal strengths and weaknesses. Further, both the job applicant and the recruiter may be subject to bias and subjectivity that thwart optimal candidate selection.

What is needed is a solution that can help to improve recruiting and job placement processes by eliminating inaccuracies and/or subjective assessments and ensuring that job candidates/applicants are appropriately matched to jobs.

### SUMMARY OF THE INVENTION

The present invention relates generally to computerized systems having artificial intelligence capabilities, and more specifically, to a computerized system and method for objective sensor-based observation and artificial-intelligence-driven analysis of physical, cognitive and social characteristics and abilities of a person, and the automated matching of the person to available job opportunities for recruiting purposes based on the various requirements of various jobs. Accordingly, job applicants are assessed using an objective hardware/sensor-based assessment of observed/measured/tracked candidate abilities/performance to determine physical, cognitive and/or social abilities. Further, job applicants are matched with job opportunities according to such observed abilities/performance. Thereby, the system may be used to remove personal bias and subjectivity generally present during hiring processes, on the part of both the recruiter and the potential employee, by systematically capturing and matching an individual's capacity for physical, cognitive, and social activities to the physical, cognitive, and social demands of a job role.

### BRIEF DESCRIPTION OF THE FIGURES

For a better understanding of the present invention, reference may be made to the accompanying drawings in which:

FIG. 1 is a system diagram showing an exemplary network computing environment in which the present invention may be employed;

FIG. 2 is a schematic block diagram illustrating an exemplary and non-limiting embodiment of a computerized Applicant Assessment Computing Device in accordance with the present invention;

FIG. 3 is a schematic block diagram illustrating an exemplary and non-limiting embodiment of a computerized Job Assessment Computing Device in accordance with the present invention;

FIG. 4 is a schematic block diagram illustrating an exemplary and non-limiting embodiment of a computerized Sensor-Based Applicant Matching System in accordance with the present invention; and

FIG. 5 is a flow diagram illustrating operation of the system in accordance with an exemplary and non-limited embodiment of the present invention.

### DETAILED DESCRIPTION

The present invention provides a computerized system including hardware for scanning/objectively observing a person's body during a pre-determined physical routine, and software to identify, evaluate, and prioritize the physical characteristics of the person.

The system also scans, ingests, and measures a person's cognitive capabilities during a pre-determined mental exercise-type routine (via a graphical user interface or other interface of the system) to identify, evaluate, and prioritize the cognitive characteristics of the person.

The system also analyzes speech patterns, facial expressions, and mannerisms including eye contact and repetitive motion to assess a person's social capabilities during a pre-determined routine (via a graphical user interface or other interface of the system) to identify, evaluate, and prioritize the social characteristics of the person.

For example, the system may actively or passively evaluate a job applicant's and/or employee's physical, cognitive and/or characteristics using spatio-temporal and kinematic analysis.

The system further includes a database of current job opportunities with the necessary requirements/tasks identified, evaluated, and prioritized that is used to compare the person's physical, cognitive and/or social characteristics against the job's necessary requirements/tasks to ensure optimal job placement.

The system may identify necessary accommodations for potential candidates, if applicable. For example, the system may identify a need for special furniture as an accommodation for a potential employee determined to have a job requiring sitting for long durations, based on information obtained by the system.

The employer and/or job candidate may provide feedback that is then incorporated into an ability/job matching algorithm to continually evolve and refine its success. For example, the system may compare observed characteristics resulting from spatio-temporal and kinematic analysis to the requirements/tasks of available jobs to match a person's characteristics to the appropriate job. Artificial intelligence may be used to help place potential work candidates in the most appropriate jobs using a job placement algorithm to evaluate candidates against job responsibilities for the purpose of job matching. For example, following placement matching a job application with a job, similar post-placement assessments may be conducted for validation (e.g., to determine whether the match was indeed a suitable match) and decision model refinement. Accordingly, the system may be used by recruiters and staffing agencies, and may be particularly advantageous in hiring of persons with physical or cognitive disabilities, such as those having motor function or sensory impairments.

The system may be used in contexts other than the job placement context. For example, the system may be configured to evaluate personal characteristics/abilities that people may have beyond just physical, cognitive and/or social. Accordingly, the system can also use system observation-based evaluation and matching for purposes other than employment. For example, the system may be used to match persons (based on observed characteristics) with other tasks, such as suitability for rides on theme parks, for hiking mountain trails, etc.

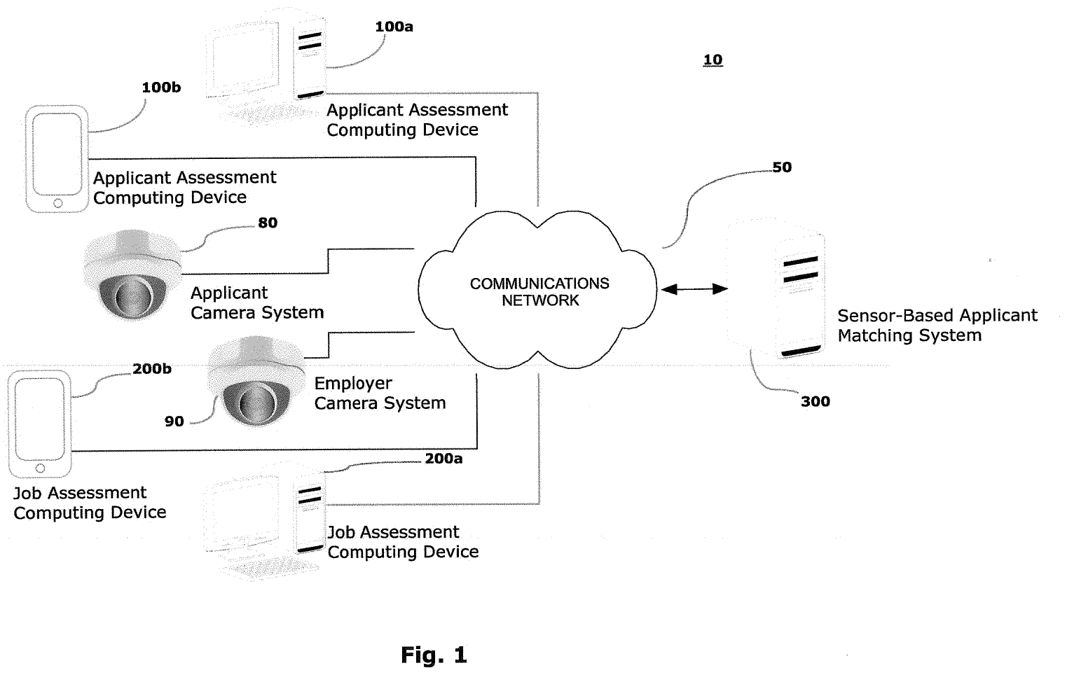

According to illustrative embodiment(s) of the present invention, various views are illustrated in FIGS. 1-4 and like reference numerals are used consistently throughout to refer to like and corresponding parts of the invention for all of the various views and figures of the drawings.

The following detailed description of the invention contains many specifics for the purpose of illustration. Anyone of ordinary skill in the art will appreciate that many variations and alterations to the following details are within the scope of the invention. Accordingly, the following implementations of the invention are set forth without any loss of generality to, and without imposing limitations upon, the claimed invention.

### System Environment

An exemplary embodiment of the present invention is discussed below for illustrative purposes. FIG. 1 is a system diagram showing an exemplary network computing environment 10 in which the present invention may be employed. As shown in FIG. 1, the exemplary network environment 10 includes certain conventional computing hardware and software for communicating via a communications network 50, such as the Internet, etc., using an Applicant Assessment Computing Device (AACD) 100a, 100b, and/or a Job Assessment Computing Device (JACD) 200a, 200b and/or a Sensor-Based Applicant Matching System (SBAMS) 300, each of which may be, for example, one or more personal computers/PCs, laptop computers, tablet computers, smartphones, or other computing system hardware, including computerized/networked communication hardware/software/functionality, such as computer-based servers, kiosks and the like, or other so-called “connected” communication devices having communication capabilities for communicating data via the network, in any form, to the user, such as smart watches, activity trackers, headphones, ear buds, televisions, or any other computerized and/or internet-of-things type device.

In accordance with a certain aspect of the present invention, one or more of the AACDs 100a, 100b and JACDs 200a, 200b is a smartphone, tablet computer, smart watch or other computing device configured to store and execute an “app” or other purpose-specific application software in accordance with the present invention, although this is not required in all embodiments. In part, the software may involve use of hardware (e.g., camera, microphone, touchscreen/keyboard, accelerometers, position/orientation sensor, etc.) and/or software of the AACDs 100a, 100b and/or JACDs 200a, 200b to capture user activity data that can be interpreted to assess the physical, cognitive and/or social characteristics and/or abilities of a person, e.g., using spatio-temporal and/or kinematic analysis, facial recognition, voice analysis and/or image processing relating to the user's use of the body in three-dimensional space, maintenance of eye contact, speech patterns, etc., as well as information involving use of the device to perform software-based assessment tasks, e.g., to assess typing speed, to assess basic motor functions, to complete software-based questionnaires for gathering information and/or to perform software-based cognitive tests/assessments, etc.

In accordance with another aspect of the present invention, the exemplary network environment 10 includes certain conventional sensor-based hardware 80, 90 distinct from the AACDs 100a, 100b and/or JACDs 200a, 200b and capable of observing the activities of a user and capturing associated data and electronically communicating it to another device, e.g., via the communications network 50. More particularly, sensor hardware may be employed that is capable of capturing user activity data that can be interpreted to assess the physical, cognitive and/or social characteristics and/or abilities of a person, e.g., using spatio-temporal and/or kinematic analysis, facial recognition, voice analysis and/or image processing, etc. For example, the hardware (e.g., camera, microphone, touchscreen/keyboard, accelerometers, position/orientation sensor, etc.) and/or software of the AACDs 100a, 100b and/or JACDs 200a, 200b to capture user activity data that can be interpreted to assess the physical, cognitive and/or social characteristics and/or abilities of a person, e.g., using spatio-temporal and/or kinematic analysis, facial recognition, voice analysis and/or image processing relating to the user's use of the body in three-dimensional space, maintenance of eye contact, speech patterns, etc. In various embodiments, the captured data may be transmitted for processing to the AACDs, JACDs, and/or the SBAMS 300. By way of example, the sensor-based hardware 80, 90 may include a camera-based imaging system capable of performing still or video images, e.g., with or with motion capture and/or motion tracking functionality, so that the user's physical, cognitive and/or social characteristics and/or abilities may be assessed.

Hardware and software for enabling communication of data by such systems via such communications networks are well known in the art and beyond the scope of the present invention, and thus are not discussed in detail herein.

### Applicant Assessment Computing Device

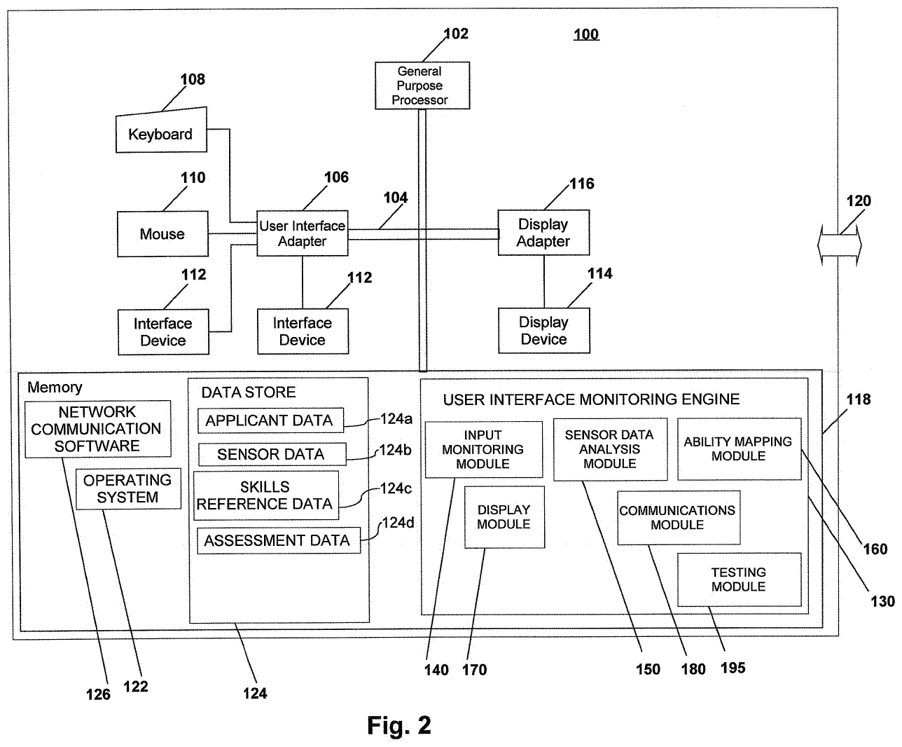

FIG. 2 is a schematic block diagram showing an exemplary Applicant Assessment Computing Device (AACD) 100/100a/100b in accordance with an exemplary embodiment of the present invention. The exemplary AACD 100 is a special-purpose computer system that includes conventional computing hardware storing and executing both conventional software enabling operation of a general-purpose computing system, such as operating system software, network communications software, and specially-configured computer software for configuring the general purpose hardware as a special-purpose computer system for carrying out at least one method in accordance with the present invention. By way of example, the communications software may include conventional web server software, and the operating system software may include iOS, Android, Windows, Linux software.

Referring again to FIG. 2, there is illustrated a block diagram of an exemplary AACD 100 according to some embodiments is shown. In some embodiments, the AACD 100 may, for example, execute, process, facilitate, and/or otherwise be associated with the embodiments and methods described herein.

Accordingly, the exemplary AACD 100 of FIG. 2 includes a general-purpose processor, such as a microprocessor (CPU), 102 and a bus 104 employed to connect and enable communication between the processor 102 and the components of the presentation system in accordance with known techniques. According to some embodiments, the processor 102 may be or include any type, quantity, and/or configuration of processor that is or becomes known. In some embodiments, the processor 102 may comprise multiple inter-connected processors, microprocessors, and/or micro-engines. According to some embodiments, the processor 102 (and/or the system 100 and/or other components thereof) may be supplied power via a power supply (not shown), such as a battery, an Alternating Current (AC) source, a Direct Current (DC) source, an AC/DC adapter, solar cells, and/or an inertial generator. In the case that the system 100 comprises a server, such as a blade server, necessary power may be supplied via a standard AC outlet, power strip, surge protector, and/or Uninterruptible Power Supply (UPS) system.

The exemplary AACD 100 includes a user interface adapter 106, which connects the processor 102 via the bus 104 to one or more interface devices, such as a keyboard 108, mouse 110, and/or other interface devices 112, which can be any user interface device, such as a touch-sensitive screen, digitized entry pad, etc. The bus 104 also connects a display device 114, such as an LCD screen or monitor, to the processor 102 via a display adapter 116.

The bus 104 also connects the processor 102 to memory 118, which can include a hard drive, a solid-state drive, an optical drive, a diskette drive, a tape drive, etc. The memory 118 may comprise any appropriate information storage system that is or becomes known or available, including, but not limited to, units and/or combinations of magnetic storage systems (e.g., a hard disk drive), optical storage systems, and/or semiconductor memory systems, such as RAM systems, Read Only Memory (ROM) systems, Single Data Rate Random Access Memory (SDR-RAM), Double Data Rate Random Access Memory (DDR-RAM), and/or Programmable Read Only Memory (PROM).

The memory 118 may, according to some embodiments, store one or more software components. Any or all of the exemplary instructions and data types described herein and other practicable types of data may be stored in any number, type, and/or configuration of memory systems that is or becomes known. The memory 118 may, for example, comprise one or more data tables or files, databases, table spaces, registers, and/or other storage structures. In some embodiments, multiple databases and/or storage structures (and/or multiple memory systems) may be utilized to store information associated with the system 100. According to some embodiments, the memory 118 may be incorporated into and/or otherwise coupled to the system 100 (e.g., as shown) or may simply be accessible to the system 100 (e.g., externally located and/or situated).

The AACD 100 may communicate with other computers or networks of computers, for example via a communications channel, network card, modem or transceiver (collectively, “transceiver”) 120. In some embodiments, the transceiver 120 may comprise any type or configuration of communication system that is or becomes known or practicable. The transceiver 120 may, for example, comprise a Network Interface Card (NIC), a telephonic system, a cellular network system, a router, a hub, a modem, and/or a communications port or cable. According to some embodiments, the transceiver 120 may also or alternatively be coupled to the processor 102. In some embodiments, the transceiver 120 may comprise an IR, RF, Bluetooth™ Near-Field Communication (NFC), and/or Wi-Fi® network system coupled to facilitate communications between the processor 102 and another system (not shown). The JACD 200 may be associated with such other computers in a local area network (LAN) or a wide area network (WAN), and may operate as a server in a client/server arrangement with another computer, etc. Such configurations, as well as the appropriate communications hardware and software, are known in the art.

In some embodiments, the AACD 100 may not be specially configured in accordance with the present invention. Rather it may be merely conventional hardware and software, and may be used in accordance with the present invention to navigate and/or interact with web pages delivered by the SBAMS 300 for the purposes described herein.

In the embodiment shown in FIG. 2, the AACD 100 is specially configured in accordance with the present invention. Accordingly, as shown in FIG. 2, the AACD 100 includes computer-readable, processor-executable instructions stored in the memory 118 for carrying out the methods described herein. Further, the memory 118 stores certain data, e.g., in one or more databases or other data stores 124 shown logically in FIG. 2 for illustrative purposes, without regard to any particular embodiment in one or more hardware or software components.

Further, as will be noted from FIG. 2, the AACD 100 includes, in accordance with the present invention, a User Interface Monitoring Engine (UIME) 130, shown schematically as stored in the memory 118, which includes a number of additional modules providing functionality in accordance with the present invention, as discussed in greater detail below. These modules may be implemented primarily by specially-configured software including microprocessor—executable instructions stored in the memory 118 of the AACD 100. Optionally, other software may be stored in the memory 118 and and/or other data may be stored in the data store 124 or memory 118. Further, the UIME 130 includes one or more modules shown logically in FIG. 2 for illustrative purposes, without regard to any particular embodiment in one or more hardware or software components.

It should be noted that some of the wording and form of description herein is done to meet applicable statutory requirements. Although the terms “step”, “block”, “module”, “engine”, etc. might be used herein to connote different logical components of methods or systems employed and/or for ease of illustration, the terms should not be interpreted as implying any particular order among or between various steps herein disclosed unless and except when the order of individual steps is explicitly described, or be interpreted as implying any distinct structure separate and apart from other structures of the system.

As shown in FIG. 2, the AACD 100 includes a data store 124 and a User Interface Monitoring Engine UIME (EPIE) 130 in accordance with the present invention. The UIME is operable to receive user-input data and/or sensor-obtained data that may be used in assessing the user's physical, cognitive and/or social abilities/skills, as discussed in greater detail below.

In part, the AACD 100 stores Applicant Data 124a in the data store 124, e.g., in a database cluster. The Applicant Data 124a identifies the job applicant/job seeker user and includes any relevant user-identified and user-associated data, such as contact and communication information. By way of example, some or all of this information may be provided by or gathered from the user by direct input or by data communication via the network 50 with the user's AACD 100.

Further, the AACD 100 stores Sensor Data 124b in the data store 124. The Sensor Data 124b is data gathered by sensor devices that are used to monitor/track/assess and/or identify activities or other aspects associated with the user when performing various tasks, e.g., as part of a test or as part of non-text activities. For example, the Sensor Data 124b may include data captured by a distinct/separate camera or camera-based imaging system 80, or by an integrated camera (or other) component of the AACD 100. By way of example, the camera/imaging system may be used to capture facial image data as well as bodily movements in space, e.g., to assess fine motor skills and gross motor skills, and abilities to pinch, grab, lift, walk, stand, etc.

Any image data useful to assess physical, cognitive and/or social abilities may be captured and used to advantage in accordance with the present invention.

The UIME 130 includes an Input Monitoring Module (IMM) 140 that is operable to receive and/or store Applicant Data 124a, and to receive and/or monitor input actively provided by the user/applicant to the AACD 100. For example, this may include a user's responses to a questionnaire gathering abilities information, or to a user's typing input as part of a typing skills test, or to a user's input as part of a cognitive skills test, etc. These types of tests may be presented to the user and be caused to be displayed via the display device 214 (by way of the Display Module 170) of the JACD 200 under control of the Testing Module 195 of the AACD, or alternatively, by a remotely-located Testing Module 395 of a centralized Sensor-Based Applicant Matching System (SBAMS 300), as discussed further below. The Testing Module may include instructions for transmitting/displaying/conducting any test that may be useful in assessing the physical, cognitive and/or social skills of the applicant. Examples of such tests include a behavioral/emotional quotient test, typing test, a reading test, a reading comprehension test, and kinesiology-focused tests. These factors may be combined according to a logic model to produce a quantitative score reflective of overall suitability of an application a job, e.g., Job Fitness Quotient (JQ) score. Additionally, the IMM 140 is operative to receive and/or monitor input passively provided by the user/applicant to the AACD 100. For example, this may involve gathering information form the user's use of the AACD 100 apart from a discrete/structured questionnaire, typing test, cognitive abilities test, etc. For example, this may involve monitoring the user's typing speed in performing unrelated tasks, such as sending emails, or texts, etc., or in monitoring lapses or delays between tasks, etc., apart from any specific tests caused to be displayed/delivered to the user via the Testing Module 195.

The UIME 130 includes a Sensor Data Analysis Module (SDAM) 140 that is operable to receive and/or store Sensor Data 124b, and analyze such data. For example, this may include processing still or video image data captured by a camera device or system and performing motion analysis to assess fine and/or gross motor skill abilities of the user/applicant. It should be noted that in alternative embodiments, the captured sensor data may be transmitted to, and be analyzed by, a similar SDAM 140 of a centralized Sensor-Based Applicant Matching System (SBAMS 300), as discussed further below. The SDAM 140 analysis functions may involve any analysis that may be useful in assessing the physical, cognitive and/or social skills of the applicant. Examples of such analyses include analyses to assess abilities to pinch, grab, lift, walk, stand, etc. as well as speak, emote, process, and act. Any suitable methodology may be used to analyze the relevant data and make suitable assessments.

The UIME 130 further includes an Ability Mapping Module (AMM) 160 that is determine the applicant user's strengths/abilities for the purposes of finding a suitable job match. The AMM 160 uses the results of the analysis by the SDAM 150 to determining the user's strengths/abilities. For example, the AMM 160 may process Applicant Data and/or other input gathered by the IMM 140 as well as the results of analyses performed by the SDAM 150 and reference a relatively comprehensive list of abilities stored as Skills Reference Data 124c in the Data Store 124, and identify that a particular user has satisfactory ability/strength for high cognitive performance, for typing, for pinching and grabbing, but not for lifting and walking (e.g., because of paralysis of the lower extremities). Accordingly, the AMM 160 processes such data, maps/associates the applicant/user's abilities/skills to a set of abilities/skills in a predefine list of abilities/skills in the Skills Reference Data 124, and stores Assessment Data 124d a list of abilities/skills that the relevant applicant/user has, so that those abilities/skills can be used to match the applicant to a job that the applicant can perform well.

The UIME 130 further includes a Communications Module (CM) 180 that is operable to receive sensor data from external devices, e.g., such as the Applicant Camera System 80) in certain embodiments. In some embodiments, some the components and functions referenced above may be performed at the remotely-located centralized SBAMS 300, and in such embodiments, the CM 180 is operable to transmit relevant data from the AACD 100 to the SBAMS 300 so that data can be processed in similar fashion at the SBAMS 300 rather than the AACD 100. In embodiments in which the data is received and analyzed at the AACD, and the Assessment Data is created at the AACD, the CM 180 is also operable to transmit the Assessment Data 124d to the SBAMS 300.

### Job-Assessment Computing Device

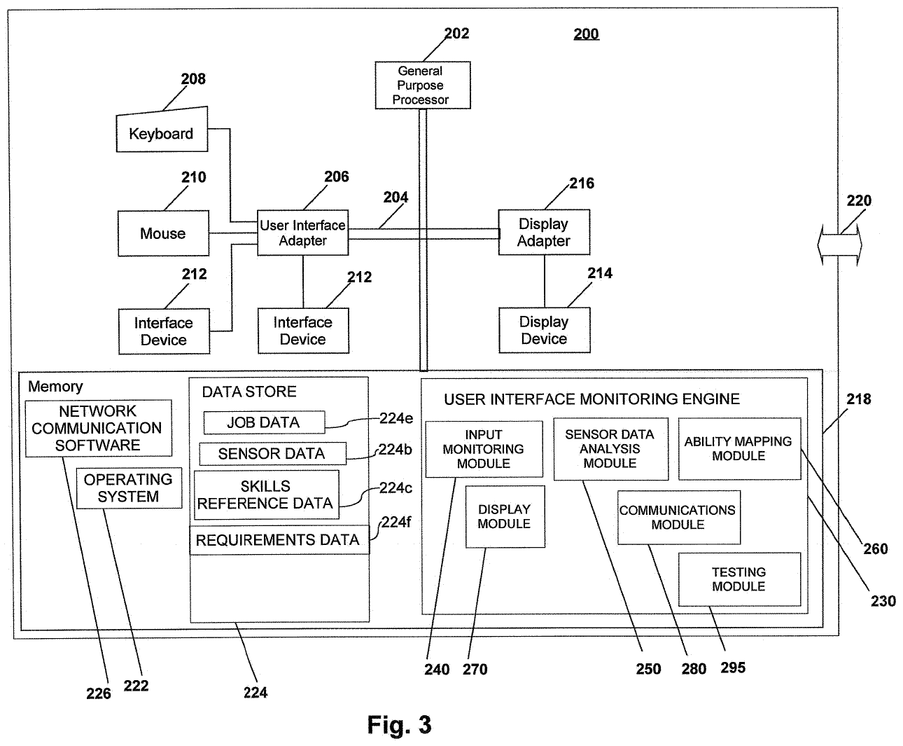

FIG. 3 is a schematic block diagram showing an exemplary Job-Assessment Computing Device (JACD) 200/200a/200b in accordance with an exemplary embodiment of the present invention. The exemplary JACD 200 is a special-purpose computer system that includes conventional computing hardware storing and executing both conventional software enabling operation of a general-purpose computing system, such as operating system software, network communications software, and specially-configured computer software for configuring the general purpose hardware as a special-purpose computer system for carrying out at least one method in accordance with the present invention. By way of example, the communications software may include conventional web server software, and the operating system software may include iOS, Android, Windows, Linux software.

Referring again to FIG. 3, there is illustrated a block diagram of an exemplary JACD 200 according to some embodiments is shown. In some embodiments, the JACD 200 may, for example, execute, process, facilitate, and/or otherwise be associated with the embodiments and methods described herein.

Accordingly, the exemplary JACD 200 of FIG. 3 includes a general-purpose processor, such as a microprocessor (CPU), 202 and a bus 204 employed to connect and enable communication between the processor 202 and the components of the presentation system in accordance with known techniques. According to some embodiments, the processor 202 may be or include any type, quantity, and/or configuration of processor that is or becomes known. In some embodiments, the processor 202 may comprise multiple inter-connected processors, microprocessors, and/or micro-engines. According to some embodiments, the processor 202 (and/or the system 200 and/or other components thereof) may be supplied power via a power supply (not shown), such as a battery, an Alternating Current (AC) source, a Direct Current (DC) source, an AC/DC adapter, solar cells, and/or an inertial generator. In the case that the system 200 comprises a server, such as a blade server, necessary power may be supplied via a standard AC outlet, power strip, surge protector, and/or Uninterruptible Power Supply (UPS) system.

The exemplary JACD 200 includes a user interface adapter 206, which connects the processor 202 via the bus 204 to one or more interface devices, such as a keyboard 208, mouse 210, and/or other interface devices 212, which can be any user interface device, such as a touch-sensitive screen, digitized entry pad, etc. The bus 204 also connects a display device 214, such as an LCD screen or monitor, to the processor 202 via a display adapter 216.

The bus 204 also connects the processor 202 to memory 218, which can include a hard drive, a solid-state drive, an optical drive, a diskette drive, a tape drive, etc. The memory 218 may comprise any appropriate information storage system that is or becomes known or available, including, but not limited to, units and/or combinations of magnetic storage systems (e.g., a hard disk drive), optical storage systems, and/or semiconductor memory systems, such as RAM systems, Read Only Memory (ROM) systems, Single Data Rate Random Access Memory (SDR-RAM), Double Data Rate Random Access Memory (DDR-RAM), and/or Programmable Read Only Memory (PROM).

The memory 218 may, according to some embodiments, store one or more software components. Any or all of the exemplary instructions and data types described herein and other practicable types of data may be stored in any number, type, and/or configuration of memory systems that is or becomes known. The memory 218 may, for example, comprise one or more data tables or files, databases, table spaces, registers, and/or other storage structures. In some embodiments, multiple databases and/or storage structures (and/or multiple memory systems) may be utilized to store information associated with the system 200. According to some embodiments, the memory 218 may be incorporated into and/or otherwise coupled to the system 200 (e.g., as shown) or may simply be accessible to the system 200 (e.g., externally located and/or situated).

The JACD 200 may communicate with other computers or networks of computers, for example via a communications channel, network card, modem or transceiver (collectively, “transceiver”) 220. In some embodiments, the transceiver 220 may comprise any type or configuration of communication system that is or becomes known or practicable. The transceiver 220 may, for example, comprise a Network Interface Card (NIC), a telephonic system, a cellular network system, a router, a hub, a modem, and/or a communications port or cable. According to some embodiments, the transceiver 220 may also or alternatively be coupled to the processor 202. In some embodiments, the transceiver 220 may comprise an IR, RF, Bluetooth™, Near-Field Communication (NFC), and/or Wi-Fi® network system coupled to facilitate communications between the processor 202 and another system (not shown). The JACD 200 may be associated with such other computers in a local area network (LAN) or a wide area network (WAN), and may operate as a server in a client/server arrangement with another computer, etc. Such configurations, as well as the appropriate communications hardware and software, are known in the art.

In some embodiments, the JACD 200 may not be specially configured in accordance with the present invention. Rather it may be merely conventional hardware and software, and may be used in accordance with the present invention to navigate and/or interact with web pages delivered by the SBAMS 300 for the purposes described herein.

In the embodiment shown in FIG. 3, the JACD 200 is specially configured in accordance with the present invention. Accordingly, as shown in FIG. 3, the JACD 200 includes computer-readable, processor-executable instructions stored in the memory 218 for carrying out the methods described herein. Further, the memory 218 stores certain data, e.g., in one or more databases or other data stores 224 shown logically in FIG. 3 for illustrative purposes, without regard to any particular embodiment in one or more hardware or software components.

Further, as will be noted from FIG. 3, the JACD 200 includes, in accordance with the present invention, a User Interface Monitoring Engine (UIME) 230, shown schematically as stored in the memory 218, which includes a number of additional modules providing functionality in accordance with the present invention, as discussed in greater detail below. These modules may be implemented primarily by specially-configured software including microprocessor—executable instructions stored in the memory 218 of the JACD 200. Optionally, other software may be stored in the memory 218 and and/or other data may be stored in the data store 224 or memory 218. Further, the UIME 230 includes one or more modules shown logically in FIG. 3 for illustrative purposes, without regard to any particular embodiment in one or more hardware or software components.

As shown in FIG. 3, the JACD 200 includes a data store 224 and a User Interface Monitoring Engine UIME (UIME) 230 in accordance with the present invention. The UIME is operable to receive user-input data and/or sensor-obtained data that may be used in assessing the user's physical, cognitive and/or social abilities/skills, as discussed in greater detail below.

In part, the JACD 200 stores Job Data 224a in the data store 224, e.g., in a database cluster. The Job Data 224a identifies the job/role and may identify a particular employee holding that job/role, and includes any relevant employer-identified and/or user-identified and/or job-associated data, such as contact and communication information. By way of example, some of this information may be provided by or gathered from a user by direct input to the JACD 200.

Further, the JACD 200 stores Sensor Data 224b in the data store 224. The Sensor Data 224b is data gathered by sensor devices that are used to monitor/track/assess or identify activities or other aspects associated with an employee's/person's activities as part of a particular job. For example, the Sensor Data 224b may include data captured by a distinct/separate camera or camera-based imaging system 90, or by an integrated camera (or other) component of the JACD 200. By way of example, the camera/imaging system may be used to capture facial image data as well as bodily movements in space, e.g., to assess fine motor skills and gross motor skills, and abilities to pinch, grab, lift, walk, stand, etc. Any image data useful to assess physical, cognitive and/or social abilities may be captured and used to advantage in accordance with the present invention. Accordingly, the JACD 200 may include hardware and/or software similar to that of the AACD 100, and may perform somewhat similar tasks, but in the case of the JACD 200, the JACD 200 is capturing data relating to an employee or other person actually performing tasks associated with a particular job, so that the system can assess in an objective (sensor hardware/software-based manner) which skills are needed for that particular job, for the purpose of matching a job applicant to an available job. Subjective, incomplete and/or inaccurate identification of skills requirements for that particular job can thereby be avoided.

The UIME 230 includes an Input Monitoring Module (IMM) 240 that is operable to receive and/or store Job Data 224a, and to receive and/or monitor input actively provided by the employee/person performing the job to the JACD 200. For example, this may include an employee's responses to a questionnaire gathering skills requirements information, or to an employee's typing input as part of a typing skills or other routine tasks performed as part of the employee's job. User interface displays for gathering this information may be presented to the employee/user and be caused to be displayed via the display device 214 (by way of the Display Module 270) of the JACD 200 under control of the Testing Module 295 of the JACD 200, or alternatively, by a remotely-located Testing Module 395 of a centralized Sensor-Based Applicant Matching System (SBAMS 300), as discussed further below. The Testing Module may include instructions for transmitting/displaying/conducting any test that may be useful in assessing the physical, cognitive and/or social skill requirements of the relevant job.

Additionally, the IMM 240 is operative to receive and/or monitor input passively provided by the employee/user to the JACD 200. For example, this may involve gathering information form the user's use of the JACD 200 apart from a discrete/structured questionnaire, etc. For example, this may involve monitoring the user's typing speed in performing unrelated tasks, such as sending emails, or texts, etc., or in monitoring lapses or delays between tasks, etc., apart from any specific tests caused to be displayed/delivered to the employee user via the Testing Module 295.

The UIME 230 includes a Sensor Data Analysis Module (SDAM) 240 that is operable to receive and/or store Sensor Data 224b, and analyze such data. For example, this may include processing still or video image data captured by a camera device or system and performing motion analysis to assess fine and/or gross motor skill abilities of the employee user while the employee user is observed performing tasks that are part of the employee's job. It should be noted that in alternative embodiments, the captured sensor data may be transmitted to, and be analyzed by, a similar SDAM 240 of a centralized Sensor-Based Applicant Matching System (SBAMS 300), as discussed further below. The SDAM 240 analysis functions may involve any analysis that may be useful in assessing the physical, cognitive and/or social skills that are used in the employee's performance of activities as part of the employee's job. Examples of such analyses include analyses to assess abilities to pinch, grab, lift, walk, stand, etc. as well as speak, emote, process, and act. Any suitable methodology may be used to analyze the relevant data and make suitable assessments.

The UIME 230 further includes an Ability Mapping Module (AMM) 260 that uses the results of the analysis by the SDAM 250 to determine the employee user's skills used in the course of performing the job, so that information can be used to define skill requirements for a job, and determine whether the job is compatible with a job applicant's skills. For example, the AMM 260 may process Job Data and/or other input gathered by the IMM 240 as well as the results of analyses performed by the SDAM 250 and reference a relatively comprehensive list of skills as Job Skills Reference Data 224c in the Data Store 224, and identify that a job requires particular skills. Accordingly, the AMM 260 processes such data, maps/associates the skills used by the employee in perform to job to a set of skills in a predefined list of skills in the Job Skills Reference Data 224c, and stores Job Requirements Data 224f that are effective a list of skills that the corresponding job requires an applicant to have in order to perform the job effectively, so that it can be determine whether this job requires skills that are compatible with skills of the applicant, to match the applicant to a job that the applicant can perform well.

The UIME 230 further includes a Communications Module (CM) 280 that is operable to receive sensor data from external devices, e.g., such as the Employee Camera System 90) in certain embodiments. In some embodiments, some the components and functions referenced above may be performed at the remotely-located centralized SBAMS 300, and in such embodiments, the CM 280 is operable to transmit relevant data from the JACD 200 to the SBAMS 300 so that data can be processed in similar fashion at the SBAMS 300 rather than the JACD 200. In embodiments in which the data is received and analyzed at the JACD 200, and the Job Requirements Data is created at the JACD 200, the CM 280 may be operable to transmit the Job Requirements Data 224d to the SBAMS 300.

### Sensor-Based Applicant Matching System

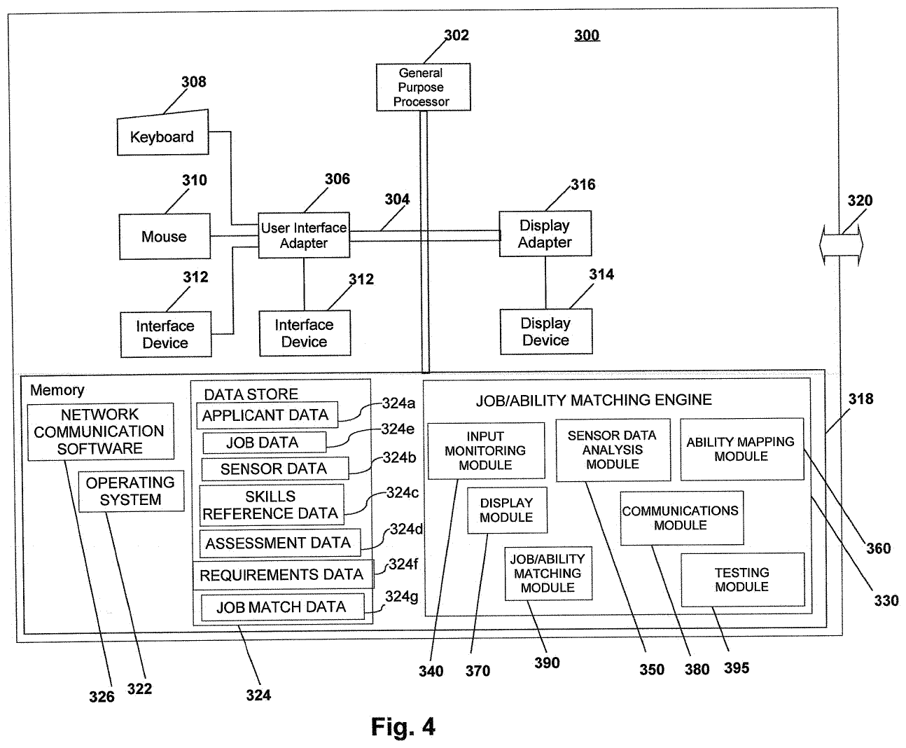

FIG. 4 is a schematic block diagram showing an exemplary Sensor-Based Applicant Matching System (SBAMS) 300 in accordance with an exemplary embodiment of the present invention. The SBAMS 300 is a special-purpose computer system that includes conventional computing hardware storing and executing both conventional software enabling operation of a general-purpose computing system, such as operating system software, network communications software, and specially-configured computer software for configuring the general purpose hardware as a special-purpose computer system for carrying out at least one method in accordance with the present invention. By way of example, the communications software may include conventional web server software, and the operating system software may include iOS, Android, Windows, Linux software.

Referring again to FIG. 4, there is illustrated a block diagram of an exemplary SBAMS 300 according to some embodiments is shown. In some embodiments, the SBAMS 300 may, for example, execute, process, facilitate, and/or otherwise be associated with the embodiments described above.

Accordingly, the exemplary SBAMS 300 of FIG. 4 includes a general-purpose processor, such as a microprocessor (CPU), 302 and a bus 304 employed to connect and enable communication between the processor 302 and the components of the presentation system in accordance with known techniques. According to some embodiments, the processor 302 may be or include any type, quantity, and/or configuration of processor that is or becomes known. In some embodiments, the processor 302 may comprise multiple inter-connected processors, microprocessors, and/or micro-engines. According to some embodiments, the processor 302 (and/or the system 300 and/or other components thereof) may be supplied power via a power supply (not shown), such as a battery, an Alternating Current (AC) source, a Direct Current (DC) source, an AC/DC adapter, solar cells, and/or an inertial generator. In the case that the system 300 comprises a server, such as a blade server, necessary power may be supplied via a standard AC outlet, power strip, surge protector, and/or Uninterruptible Power Supply (UPS) system.

The exemplary SBAMS 300 includes a user interface adapter 306, which connects the processor 302 via the bus 304 to one or more interface devices, such as a keyboard 308, mouse 310, camera device 312 and/or other interface devices 314, which can be any user interface device, such as a microphone, biometric sensor, touch sensitive screen, digitized entry pad, etc. The bus 304 also connects a display device 314, such as an LCD screen or monitor, to the processor 302 via a display adapter 316.

The bus 304 also connects the processor 302 to memory 318, which can include a hard drive, a solid-state drive, an optical drive, a diskette drive, a tape drive, etc. The memory 318 may comprise any appropriate information storage system that is or becomes known or available, including, but not limited to, units and/or combinations of magnetic storage systems (e.g., a hard disk drive), optical storage systems, and/or semiconductor memory systems, such as RAM systems, Read Only Memory (ROM) systems, Single Data Rate Random Access Memory (SDR-RAM), Double Data Rate Random Access Memory (DDR-RAM), and/or Programmable Read Only Memory (PROM).

The memory 318 may, according to some embodiments, store one or more software components. Any or all of the exemplary instructions and data types described herein and other practicable types of data may be stored in any number, type, and/or configuration of memory systems that is or becomes known. The memory 318 may, for example, comprise one or more data tables or files, databases, table spaces, registers, and/or other storage structures. In some embodiments, multiple databases and/or storage structures (and/or multiple memory systems) may be utilized to store information associated with the system 300. According to some embodiments, the memory 318 may be incorporated into and/or otherwise coupled to the system 300 (e.g., as shown) or may simply be accessible to the system 300 (e.g., externally located and/or situated).

The SBAMS 300 may communicate with other computers or networks of computers, for example via a communications channel, network card, modem or transceiver (collectively, “transceiver”) 320. In some embodiments, the transceiver 320 may comprise any type or configuration of communication system that is or becomes known or practicable. The transceiver 320 may, for example, comprise a Network Interface Card (NIC), a telephonic system, a cellular network system, a router, a hub, a modem, and/or a communications port or cable. According to some embodiments, the transceiver 320 may also or alternatively be coupled to the processor 302. In some embodiments, the transceiver 320 may comprise an IR, RF, Bluetooth™, Near-Field Communication (NFC), and/or Wi-Fi® network system coupled to facilitate communications between the processor 302 and another system (not shown). The SBAMS 300 may be associated with such other computers in a local area network (LAN) or a wide area network (WAN), and may operate as a server in a client/server arrangement with another computer, etc. Such configurations, as well as the appropriate communications hardware and software, are known in the art.

The SBAMS 300 is specially configured in accordance with the present invention. Accordingly, as shown in FIG. 4, the SBAMS includes computer-readable, processor-executable instructions stored in the memory 318 for carrying out the methods described herein. Further, the memory 318 stores certain data, e.g., in one or more databases or other data stores 324 shown logically in FIG. 3 for illustrative purposes, without regard to any particular embodiment in one or more hardware or software components.

Further, as will be noted from FIG. 4, the SBAMS 300 includes, in accordance with the present invention, a Job/Ability Matching Engine (JAME) 330, shown schematically as stored in the memory 318, which includes a number of additional modules providing functionality in accordance with the present invention, as discussed in greater detail below. These modules may be implemented primarily by specially-configured software including microprocessor—executable instructions stored in the memory 318 of the SBAMS 300. Optionally, other software may be stored in the memory 318 and and/or other data may be stored in the data store 324 or memory 318. Further, the SAMDE 330 includes one or more modules shown logically in FIG. 4 for illustrative purposes, without regard to any particular embodiment in one or more hardware or software components.

As shown in FIG. 4, the SBAMS 300 includes a data store 324 and a Job/Ability Matching Engine (JAME) 330 in accordance with the present invention. The exemplary JAME 330 is operable to receive at least user/applicant Assessment Data 224d/324d from the UIME 130 of the AACD 100, and at least Job Requirements Data 224f/324f from the UIME 230 of the JACD 200, as discussed in greater detail below. In such embodiments, the JAME 330 may omit components such as the IMM 340, SDAM 350, and AMM 360, which correspond to similar components described above with reference to the AACD 100 and JACD 200. In other embodiments, the JAME 300 may include some or all of such components, and may receive data such as Applicant Data 324a, Job Data 324e, Sensor Data 324b, Ability Reference Data 324c and Assessment Data 324d, for the purposes, and perform the functions associated with those components as described above with reference to the AACD 100 and JACD 200. Accordingly, data may be gathered and processed at any suitable device within the system. The JAME 330 may include a Communications Module 380, Testing Module 395 and/or Display Module of types similar to those described above, e.g., for causing displays at the AACD 100, JACD 200 and/or JAME 330, for communicating data to the AACD 100, JACD 200, etc. across the network 50, etc., in manners similar to those described above.

Additionally, the JAME 330 includes a Job/Ability Matching Module (JAMM) 390. The JAMM 390 is operable to compare Job Skills Requirements Data 324f to Applicant Assessment Data 324d, and to identify which job or jobs have job skill requirements that are compatible with skills of a certain applicant, and/or which applicants have observed abilities that are compatible with job skills requirement for a certain job. The JAMM 390 stores the results of its matching process as Job Match Data 324g in the Data Store 324 of the SBAMS 300. Those results may subsequently be transmitted (e.g., by operation of the CM 380) to a computing device of the job applicant, an employer having an open job, a recruiter, an HR professional, etc.

As used herein, compatible may mean that an applicant has been determined to have all, or fewer than all, of the skills required for a particular job. Additionally, compatible may mean that there is not an exact match between applicant skills and job requirements but the differences can be identified so that accommodations can be considered that would enable the applicant to perform a particular job. In certain embodiments, the JAMM 390 may automatedly propose or identify specific accommodations, and may seek approval of proposed accommodations on the part of the applicant, employer, recruiter, etc., which may be obtained by notifying the involved parties via a suitable data communication and obtaining a responsive data communication approving or disapproving of the accommodation. Any suitable logic or techniques may be used for determining whether a job applicant's skills and a job's skill requirements are compatible, as desired.

### System Operation

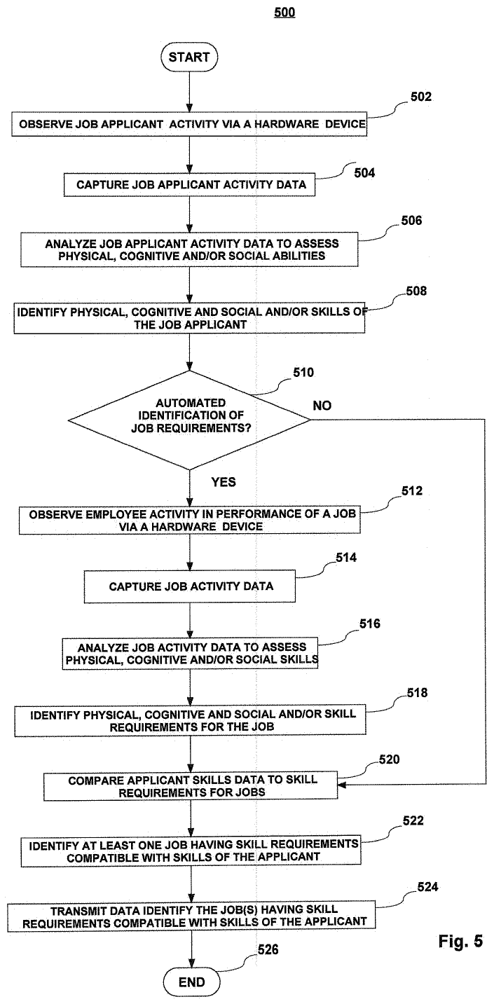

Exemplary operation of the system of FIGS. 1-4 is discussed below with reference to the flow diagram 500 of FIG. 5.

Referring now to FIG. 5, it will be appreciated that an exemplary method of operation of a system in accordance with the present invention involves the system observing job applicant user activity via a hardware device, as shown at 502. This may involve, for example, use of a camera or other imaging device of an AACD 100 or of an independent Applicant Camera System 80 to observe a user's face and facial expressions, and/or to capture a user's bodily moments, e.g., in performing specific tasks or tests, e.g., as part of tests delivered as part of a structure assessment/evaluation, either by the SBAMS 300, AACD 100 or JACD 200 with or without involvement of the clinician. Additionally, this may involve the AACD 100 monitoring/observing the job applicant user's manner of interaction with the AACD 100 or another device, e.g., passively, e.g., as part of use of the device in everyday activities, e.g., to type, test, call, browse the internet, etc. As part of this step, job applicant user data may be gathered (e.g., by the IMM 140) and stored at the AACD 100 as Applicant Data 124a (and/or be communicated to the SBAMS 300 and/or be gathered by the IMM 340 and be stored at the SBAMS 300 as Applicant Data 324a).

The exemplary method next involves capturing job applicant user activity data using such hardware device, as shown at 504. This may involve the sensor/hardware device and/or any associated device capturing associated data so that the data can be used according to the purposes herein to assess the job applicant and identify job-relevant skills (e.g., physical, cognitive and/or social skills) that are possessed by the job applicant, to assist in matching the job applicant with a suitable job/role, according to the skill requirements of that job/role. Any appropriate data may be captured using any suitable sensor, and may be stored by Applicant Camera System 80 and/or the AACD 100 as Sensor Data 124b (and/or be communicated to (e.g., via the communications network 50), and/or be gathered by the IMM 340, and stored by the SBAMS 300 as Sensor Data 324b).

The exemplary method next involves analyzing the job applicant user activity data to assess physical, cognitive and/or social abilities of the job applicant, as shown at 506. As will be appreciated from the discussion above, this may be performed by the SDAM 150 of the AACD 100 and/or by the SDAM 350 of the SBAMS 300. By way of example, this may involve motion tracking and/or image analysis/processing and/or motion analysis techniques, facial recognition/emotion analysis techniques, voice analysis techniques, and behavioral response techniques. By way of example, the analysis may result in an identification of a video segment involving the user's walking and/or assessment of how well a user can walk during a walking test administered under control of the AACD 100 and/or the SBAMS 300, or during everyday activities apart from any such test.

The exemplary method next involves identifying physical, cognitive and/or social skills possessed by the job applicant, as shown at 508. As will be appreciated from the discussion above, this may be performed by the AAM 160 of the AACD 100 and/or by the SDAM 360 of the SBAMS 30. By way of example, this may involve referencing stored Skills Reference Data 124c (e.g., a comprehensive list of skills that may be possessed by job applicants and that may be relevant for various jobs), and determining which of those skills are possessed by the particular job applicant user. By way of example, the analysis of a video segment involving the user's movement during a walking test administered under control of the AACD 100 and/or the SBAMS 300, or during everyday activities apart from any such test, may identify that the user can walk adequately/appropriate, and therefore possesses the “walking” skill, or may confirm that the user does not possess the “walking” skill because the user cannot walk or cannot walk adequately. Another example is a behavioral test that assesses the job applicant's responses in accordance targeted job-relevant objectives and norms. Other examples of job skill requirements include an ability to lift or push heavy objects (e.g., push a patient in a wheelchair), read at a particular grade level (e.g., read expiration dates to identify expired medications), maintain eye contact (e.g., in greeting a patient at a doctor's office), etc. The AMM 160/360 thereby identifies skills that are deemed to be possessed by a particular job applicant user (based on objective observation of job applicant activities using hardware sensors and automated analysis of data captured via such sensors), and stores the list of skills possessed by that user/job applicant as Applicant Assessment Data 124d/324d.

The system identifies the associated skills for a particular job through monitoring an individual or individuals currently performing the job. The system may then analyze the skill requirements and assign a priority level or ranking to each observed skill based upon the frequency of observed occurrence, for example.

In certain embodiments, the system does not involve automated identification of job skill requirements, but rather uses a predefined list of job skill requirements for job matching purposes. Accordingly, in the exemplary method of FIG. 4, if it is determined at 510 that the system does not involve automated identification of job skill requirements, then the system compares the job applicant's skills data to skill requirements for one or more jobs, as shown at 520. In the exemplary embodiment, this is performed by the Job/Ability Matching Module 390 of the SBAMS 300, by reference to the relevant job applicant Assessment Data 324d, and Skill Requirement Data 324f for one or more jobs.

In the exemplary embodiment, the method next involves identifying at least one job having skill requirements compatible with skills of the job applicant, as shown at 522. This may be performed by the JAMM 390, which may then store corresponding data as Job Match Data 324g in the data store 324 of the SBAMS 300.

In the exemplary embodiment, the method next involves transmitting data identifying at least one job determined to have job skill requirements compatible with the skills of the applicant, as shown at 524, and the exemplary method ends, as shown at 526. This may be performed by the JAMM 390 acting in concert with the Communications Module 380, which may, for example, transmit corresponding data via the network 50 to a job applicant (e.g., using the Applicant Data 324a), to an employer/HR person and/or recruiter (e.g., using the Job Data), etc.

In some embodiments, the system may not only perform job applicant assessment of skills based on objective observation of job applicant activities using hardware sensors and automated analysis of data captured via such sensors, but also perform job role assessment of job skill requirements based on objective observation of an employee or other person performing job/role activities using hardware sensors and automated analysis of data captured via such sensors.

Accordingly, the exemplary method further includes a determination of whether the system includes automated identification of job skill requirements, as shown at 510. If so, then the method involves the system observing an employee's (or another person's) activities in the course of performance of a particular job/job role via a hardware device, as shown at 512. This may involve, for example, use of a camera or other imaging device of an JACD 200 or of an independent Employer Camera System 90 to observe a user's face and facial expressions, and/or to capture a user's bodily moments, e.g., in performing specific tasks that are part of a particular job/role (which may include, for example, standing, sitting, typing, lifting, pinching, speaking, etc.). Additionally, this may involve the JACD 200 monitoring/observing the employee's manner of interaction with the JACD 200 or another device, e.g., passively, e.g., as part of use of the device in everyday job/role activities, e.g., to type, text, call, operate equipment, etc. As part of this step, job role data may be gathered (e.g., by the IMM 240) and stored at the JACD 100 as Job Data 224e (and/or be communicated to the SBAMS 300 and/or be gathered by the IMM 340 and be stored at the SBAMS 300 as Job Data 324e).

The exemplary method next involves capturing employee job activity data using such hardware device, as shown at 514. This may involve the sensor/hardware device and/or any associated device capturing associated data so that the data can be used according to the purposes herein to identify job-relevant skills (e.g., physical, cognitive and/or social skills) that are required for the job/role, to assist in matching a job applicant with a suitable job/role, according to the skill requirements of that job/role. Any appropriate data may be captured using any suitable sensor, and may be stored by Employer Camera System 90 and/or the JACD 200 as Sensor Data 224b (and/or be communicated to (e.g., via the communications network 50), and/or be gathered by the IMM 340, and stored by the SBAMS 300 as Sensor Data 324b).

The exemplary method next involves analyzing the job activity data to assess physical, cognitive and/or social activities of the employee/person in the course of performance of the job, as shown at 516. As will be appreciated from the discussion above, this may be performed by the SDAM 250 of the JACD 200 and/or by the SDAM 350 of the SBAMS 300. By way of example, this may involve motion tracking and/or image analysis/processing and/or motion analysis techniques, facial recognition/emotion analysis techniques, voice analysis techniques, and behavioral response techniques. By way of example, the analysis may result in an identification of a video segment involving the user's walking during performance of a test or as part of job activities apart from any such test.

The exemplary method next involves identifying physical, cognitive and/or social skills used/required in the job/role, as shown at 518. As will be appreciated from the discussion above, this may be performed by the AAM 260 of the JACD 200 and/or by the SDAM 360 of the SBAMS 30. By way of example, this may involve referencing stored Skills Reference Data 124c (e.g., a comprehensive list of skills that may be possessed by job applicants and that may be relevant for various jobs), and determining which of those skills are possessed by the particular job applicant user. By way of example, the analysis of a video segment involving the user's movement during a walking test administered under control of the AACD 100 and/or the SBAMS 300, or during everyday activities apart from any such test, may identify that the user can walk adequately/appropriate, and therefore possesses the “walking” skill, or may confirm that the user does not possess the “walking” skill because the user cannot walk or cannot walk adequately. Another example is a behavioral test that assesses the job applicant's responses in accordance targeted job-relevant objectives and norms. The AMM 260/360 thereby identifies skills that are deemed to be required for a particular job/role (based on objective observation of employee/job activities using hardware sensors and automated analysis of data captured via such sensors), and stores the list of required skills for the job/role as Job Requirements Data 224f/324f.

In certain embodiments, the skill identified may be added to a list of skills used by the AMM in matching observed job applicant activities to skills, in assessing the physical, cognitive and/or social abilities of job applicants.

The method next involves comparing applicant skills data to skill requirements for jobs, identifying at least one job having skill requirements compatible with skills of the application, and transmitting data identifying the job(s) having skill requirements compatible with the skill(s) of the job application, as shown at 520, 422 and 524, and as discussed in greater detail above.

Notably, steps 502-508, 520, 522 and 524 may be performed repeatedly for various applicants, or repeatedly for a single applicant to build a robust data store of job applicants and their respective skills. Additionally, steps 512-518 may be performed repeatedly for various jobs and/or employers, and may be performed before, after and/or concurrently with steps 502-508, 520, 522 and 524, as should be appreciated by those skilled in the art.

Accordingly, in certain cases, a job applicant may apply for a specific job, and the JAMM 390 may compare Assessment Data 324d for a particular application to Skill Requirement Data 324f for that particular job, which may result in a conclusion that the applicant is or is not well-suited to performing that particular job. However, in other cases, the job applicant may not apply for any specific job, and the JAMM 390 may compare Assessment Data 324d for a particular application to Skill Requirement Data 324f for many different jobs, which may result in a conclusion that the job applicant is not well-suited to certain jobs but is well-suited to performing one or more specific jobs. Accordingly, in certain embodiments, a job applicant's skills may be inventoried, and then may be used to find any/many suitable jobs for that job applicant. Notably, the search for suitable jobs may involve comparing the Assessment Data 324d for a particular application to Skill Requirements Data 324f corresponding to jobs at many different employers. This may be particularly helpful in cases in which job applicants have somewhat limited or particularly unique sets of skills, such as for differently-abled persons or others for which finding a suitable job match may be relatively more difficult than in other cases. Additionally, the system may captures certain characteristics/skills that are not easily recognized by the human eye (especially during a traditional interview) and removes an element of bias or subjectivity that a human may have toward a particular group or an individual.

It should be appreciated that the exemplary embodiment described above is for illustrative purposes only, and non-limiting. For example, certain functionality was described above for illustrative clarity in relation to functions performed at the AACD 100, JACD 200 and SBAMS 300 separately. However, it should be appreciated that in other embodiments, some or all of the structure and functionality described in relation to each of the AACD 100, JACD 200 and SBAMS 300 may instead be incorporated into another one of the AACD 100, JACD 200 and/or SBAMS 300. For example, the functionality of the AACD 100 or JACD 200 may be incorporated in whole or in part the SBAMS 300. By way of further example, the functionality of the SBAMS 300 may be incorporated in whole or in part into the AACD 100 and/or JACD 200.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A sensor-based applicant-matching system comprising:
a memory operatively comprising a non-transitory data processor-readable medium;
a data processor operatively connected to the memory;
applicant sensor hardware operatively connected to the data processor and operable to capture applicant activity data relating to abilities of the applicant;
user interface management instructions embodied in data processor-executable code stored in the memory, said user interface management instructions being executable by the data processor to provide a user interface monitoring engine configured to:
observe applicant activity via the applicant sensor hardware;
capture applicant activity data via the applicant sensor hardware;
analyze the applicant activity data to assess abilities of the applicant;
identify skills of the applicant; and
compare skills of the applicant to skills requirements of at least one role.

2. The sensor-based applicant-matching system of claim 1, wherein said user interface management instructions further comprise instructions to:
identify at least one role having skill requirements compatible with identified skills of the applicant.

3. The sensor-based applicant-matching system of claim 2, wherein said user interface management instructions further comprise instructions to:
transmit data, to a computing device via a data communication network, to identify at least one role have skill requirements compatible with identified skills of the applicant.

4. The sensor-based applicant-matching system of claim 1, wherein the applicant is a job applicant and wherein the role is a job.

5. The sensor-based applicant-matching system of claim 1, wherein the applicant activity data captured is at least one of physical ability data, cognitive ability data and social ability data.

6. The sensor-based applicant-matching system of claim 1, wherein the applicant sensor hardware comprises one of a camera, a microphone, a touchscreen, a keyboard, an accelerometer, a position sensor, and an orientation sensor.

7. The sensor-based applicant-matching system of claim 6, wherein the applicant sensor hardware is an integrated component of at least one of a smartphone, a tablet computer, a laptop computer, a notebook computer, a desktop computer, and a wearable computing device.

8. The sensor-based applicant-matching system of claim 1, wherein at least one of the instructions configured to analyze the applicant activity data to perform at least one of assess abilities of the applicant and identify skills of the applicant comprises instructions to perform at least one of a spatio-temporal analysis, kinematic analysis, a facial recognition analysis, a voice analysis, an image processing analysis, a motion analysis and a motion tracking analysis.

9. The sensor-based applicant-matching system of claim 1, wherein at least one of the instructions configured to analyze the applicant activity data to perform at least one of assess abilities of the applicant and identify skills of the applicant comprises instructions to use a computing device to perform a software-based assessment selected from a group consisting of a fine motor skills test, a gross motor skills test, a cognitive assessment test, a behavioral skills test, an emotional quotient test, a typing test, a reading test, a reading comprehension test, a kinesiology test, and a questionnaire.

10. The sensor-based applicant-matching system of claim 1, wherein the instructions to identify skills of the applicant comprises instructions to reference stored skills reference data comprising a list of skills and map ability assessment data to at least one skill identified in the skills reference data.

11. The sensor-based applicant-matching system of claim 1, wherein the instructions to observe applicant activity via the applicant sensor hardware comprise instructions to observe the applicant activity actively as part of the applicant's affirmative actions in performing a specific assessment task.

12. The sensor-based applicant-matching system of claim 1, wherein the instructions to observe applicant activity via the applicant sensor hardware comprise instructions to observe the applicant activity passively apart from the applicant's affirmative actions in performing a specific assessment task.

13. The sensor-based applicant-matching system of claim 1, further comprising:
role sensor hardware operatively connected to the data processor and operable to capture role activity data relating to at least one skill used in performance of the role;
wherein said user interface management instructions further comprise instructions to:
observe role activity via the role sensor hardware;
capture role activity data via the role sensor hardware;
analyze the role activity data to assess skills of a person performing the role; and
identify skills requirements for performance of the role.

14. The sensor-based applicant-matching system of claim 13, wherein the instructions to identify skills requirements for performance of the role comprise instructions to prioritize each skill identified for the role.

15. The sensor-based applicant-matching system of claim 13, further comprising adding identified skills requirements for performance of the role to the stored skills reference data comprising the list of skills.

16. A computer-implemented method of controlling a computerized device to provide sensor-based applicant matching, the computerized device comprising a memory operatively comprising a non-transitory data processor-readable medium, a data processor operative connected to the memory, applicant sensor hardware operatively connected to the data processor and operable to capture applicant activity data relating to abilities of the applicant, and user interface management instructions embodied in data processor-executable code stored in the memory and executable by the data processor, the method comprising:
observing applicant activity via the applicant sensor hardware;
capturing applicant activity data via the applicant sensor hardware;
analyzing the applicant activity data to assess abilities of the applicant;
identifying skills of the applicant; and
comparing skills of the applicant to skills requirements of at least one role.

17. The method of claim 16, further comprising:
identifying at least one role having skill requirements compatible with identified skills of the applicant.

18. The method of claim 16, further comprising:
transmitting data, to a computing device via a data communication network, to identify at least one role have skill requirements compatible with identified skills of the applicant.

19. The method of claim 16, wherein at least one of said analyzing and said identifying comprises performing at least one of a spatio-temporal analysis, kinematic analysis, a facial recognition analysis, a voice analysis, an image processing analysis, a motion analysis and a motion tracking analysis.

20. The method of claim 16, wherein at least one of said analyzing and said identifying comprises performing a software-based assessment selected from a group consisting of a fine motor skills test, a gross motor skills test, a cognitive assessment test, a behavioral skills test, an emotional quotient test, a typing test, a reading test, a reading comprehension test, a kinesiology test, and a questionnaire.

21. The method of claim 16, wherein said observing comprises observing the applicant activity actively as part of the applicant's affirmative actions in performing a specific assessment task.

22. The method of claim 16, wherein said observing comprises observing the applicant activity passively apart from the applicant's affirmative actions in performing a specific assessment task.

23. The method of claim 16, wherein said computerized device further comprises role sensor hardware operatively connected to the data processor and operable to capture role activity data relating to at least one skill used in performance of the role, and wherein said method further comprises:
observing role activity via the role sensor hardware;
capturing role activity data via the role sensor hardware;
analyzing the role activity data to assess skills of a person performing the role; and
identifying skills requirements for performance of the role.

24. The method of claim 23, wherein said identifying comprises prioritizing each skill identified for the role.

25. The method of claim 23, further comprising adding identified skills requirements for performance of the role to the stored skills reference data comprising the list of skills.

26. A computer program product for implementing a method of controlling a display of a computerized device, the computer program product comprising a non-transitory computer-readable medium storing executable instructions that, when executed by a processor, cause a sensor-based applicant-matching system to perform a method comprising:
observing applicant activity via the applicant sensor hardware;
capturing applicant activity data via the applicant sensor hardware;
analyzing the applicant activity data to assess abilities of the applicant;
identifying skills of the applicant; and
comparing skills of the applicant to skills requirements of at least one role.

27. The method of claim 26, further comprising:
identifying at least one role having skill requirements compatible with identified skills of the applicant.

28. The method of claim 26, further comprising:
transmitting data, to a computing device via a data communication network, to identify at least one role have skill requirements compatible with identified skills of the applicant.

29. The method of claim 26, wherein at least one of said analyzing and said identifying comprises performing at least one of a spatio-temporal analysis, kinematic analysis, a facial recognition analysis, a voice analysis, an image processing analysis, a motion analysis and a motion tracking analysis.

30. The method of claim 26, wherein at least one of said analyzing and said identifying comprises performing a software-based assessment selected from a group consisting of a fine motor skills test, a gross motor skills test, a cognitive assessment test, a behavioral skills test, an emotional quotient test, a typing test, a reading test, a reading comprehension test, a kinesiology test, and a questionnaire.

31. The method of claim 26, wherein said observing comprises observing the applicant activity actively as part of the applicant's affirmative actions in performing a specific assessment task.

32. The method of claim 26, wherein said observing comprises observing the applicant activity passively apart from the applicant's affirmative actions in performing a specific assessment task.

33. The method of claim 26, wherein said computerized device further comprises role sensor hardware operatively connected to the data processor and operable to capture role activity data relating to at least one skill used in performance of the role, and wherein said method further comprises:
observing role activity via the role sensor hardware;
capturing role activity data via the role sensor hardware;
analyzing the role activity data to assess skills of a person performing the role; and
identifying skills requirements for performance of the role.

34. The method of claim 33, wherein said identifying comprises prioritizing each skill identified for the role.

35. The method of claim 33, further comprising adding identified skills requirements for performance of the role to the stored skills reference data comprising the list of skills.
